(19) United States
(12) Patent Application Publication
(10) Pub. No.: US 2017/0062911 A1
(43) Pub. Date: Mar. 2, 2017

(54) INPUT SELECTIVE SMART BIAS TEE

(71) Applicant: COMMSCOPE TECHNOLOGIES LLC, Hickory, NC (US)

(72) Inventors: RAY K. BUTLER, ALLEN, TX (US); SAMMIT PATEL, Richardson, TX (US); CHARLES BUONDELMONTE, Sachse, TX (US)

(21) Appl. No.: 15/120,179

(22) PCT Filed: Feb. 10, 2015
(86) PCT No.: PCT/US2015/015237

§ 371 Date: Aug. 19, 2016

Related U.S. Application Data
(60) Provisional application No. 61/943,156, filed on Feb. 21, 2014.

(51) Int. Cl. H01Q 1/24; H01Q 1/12

(52) U.S. Cl. CPC H01Q 1/246; H01Q 1/1228

(57) ABSTRACT

The Invention comprises a method and Interface for powering and controlling an antenna, having an RF signal input, an AISG signal input, including a DC current, wherein the RF signal input is coupled to the antenna by a filter, so the filter blocks a signal with DC current, and the AISG signal is coupled to the antenna through a switch, so that if an AISG signal is present, the switch automatically allows the AISG signal through to the antenna for control of the antenna, and if no AISG signal is present, the RF signal is automatically allowed through to the antenna for control of the antenna.

This application claims priority from U.S. provisional application Ser. No. 61/943,156, filed Feb. 21, 2014.

Smart Bias Tees (SBT) are often used inside antennas to allow power and control signals for an actuator to be transmitted to the antenna via an RF coax cable rather than a separate multi-conductor cable. At the base of the tower, a first SBT puts the power and control onto the RF cable. At the top of the tower, a second SBT pulls it back off See, for example, US Pat. App. Pub. No. 2007/0161348 (the “348 Application”), which is incorporated by reference.

A known application of SBTs is illustrated in FIG. 1. An electrical downtilt of an antenna beam may be controlled by a Remote Electrical Tilt (RET) device 15. A Base Station may comprise three or more such antennas mounted on a tower. A system 10 comprises a control subsystem 16 which interfaces with the RETs 15, a radio 17 which interfaces with the antennae 13, and a DC power supply 18 which provides DC power for all components of the systems 10 and 12. RET Devices may be mounted internally or externally to an antenna system.

The control subsystem 16 generates RET control data which is transmitted over a point-to-multipoint serial network to the RETs 15, each of which is assigned a unique bus address, and the RETs generate RET status data which is returned to the control subsystem 16. Similarly, the radio 17 transmits downlink RF signals to the antennae 13, and receives uplink RF signals from the antennae 13.

The RET control data on line 26, a DC bias signal on line 51, and the downlink RF signals on line 52, are multiplexed onto a single coaxial RF feeder cable 24 by a first smart bias tee 25 in the system 10. A second smart bias tee 23 in the system 12 demultiplexes the RET control data onto a line 22, the DC bias signal onto a line 53, and the downlink RF signals onto a line 54. Similarly, the RET status data and the uplink RF signals are multiplexed onto the cable 24 by the second smart bias tee 23, and the first smart bias tee 25 demultiplexes the RET status data and uplink RF signals from the cable 24.

The smart bias tees 23, 25 incorporate microprocessors 30, 40 shown schematically in FIG. 2. These microprocessors can be addressed for routine monitoring purposes, without requiring an operator to climb a tower to attach specialist equipment, and without disturbing the RF path to the antennae 13. The smart bias tees comprises microprocessors 30, 40, configuration memories 31, 41, serial interfaces 32, 42, connecting switches 35, 45, modems 33, 43, multiplexer/demultiplexer elements 34, 44, and DC voltage and/or current measurement devices 55, 56.

Using SBTs to provide DC power and control signals to tower-mounted equipment becomes more complex with multi-band antennas. In particular, a current issue is that there are certain advantages to employing a standard antenna interface that utilizes blind mate, capacitively coupled, coaxial connectors. However, because capacitively coupled connectors are inherently unable to convey DC power across the connection interface because of the DC blocking characteristics, conventional smart bias tees cannot be used to convey power to tower-mounted equipment using such connectors. Accordingly, there exists a need for a more flexible structure for communicating AISG control signals and DC power to RET Antennas and other tower-mounted equipment.

### SUMMARY OF THE INVENTION

The Invention comprises an Interface for powering and controlling an antenna, having an RF signal input, an AISG signal input, including a DC current, wherein the RF signal input is coupled to the antenna by a filter, so the filter blocks a signal with DC current, and the AISG signal is coupled to the antenna through a switch, so that if an AISG signal is present, the switch automatically allows the AISG signal through to the antenna for control of the antenna, and if no AISG signal is present, the RF signal is automatically allowed through to the antenna for control of the antenna.

The Invention also comprises a method for powering and controlling an antenna through an Interface, including providing an RF signal input, providing an AISG signal input, including a DC current, coupling the RF signal input through the Interface and a filter to the antenna, the filter blocking a signal with DC current, and coupling the AISG signal to the antenna through a switch, whereby if an AISG signal and a DC current is sensed, the switch automatically allows the AISG signal through to the antenna for control of the antennas, and if no AISG signal or DC current is sensed, the RF signal is automatically allowed through to the antenna for control of the antenna.

### CONCISE DESCRIPTION OF THE DRAWINGS

In the accompanying drawings, which form a part of the specification and which are to be read in conjunction therewith, and in which like referenced numbers are used to indicate like parts in the various views:

FIG. 1 is a schematic of a prior art Smart Bias Tee.

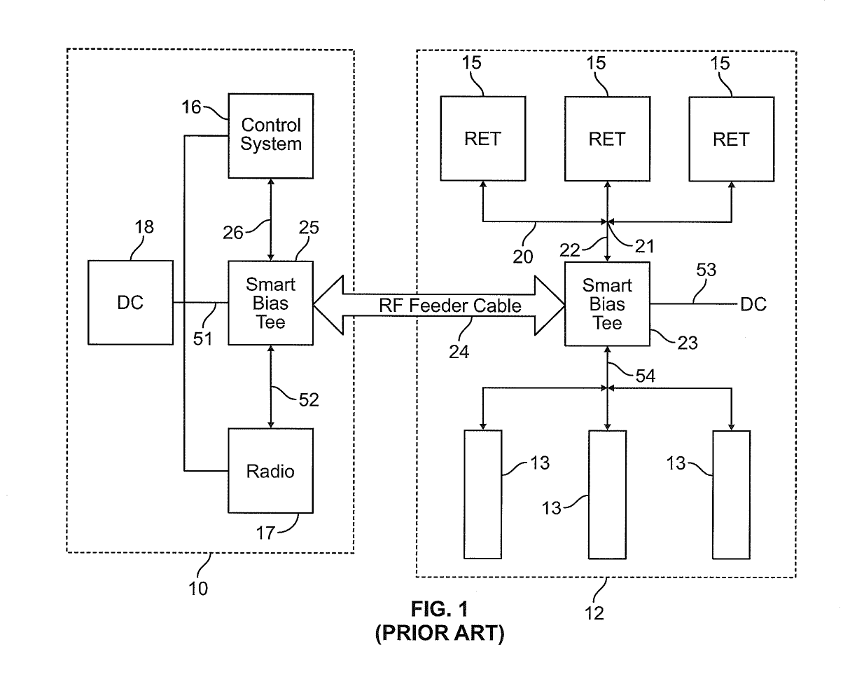

FIG. 2 is a further schematic of a prior art Smart Bias Tee.

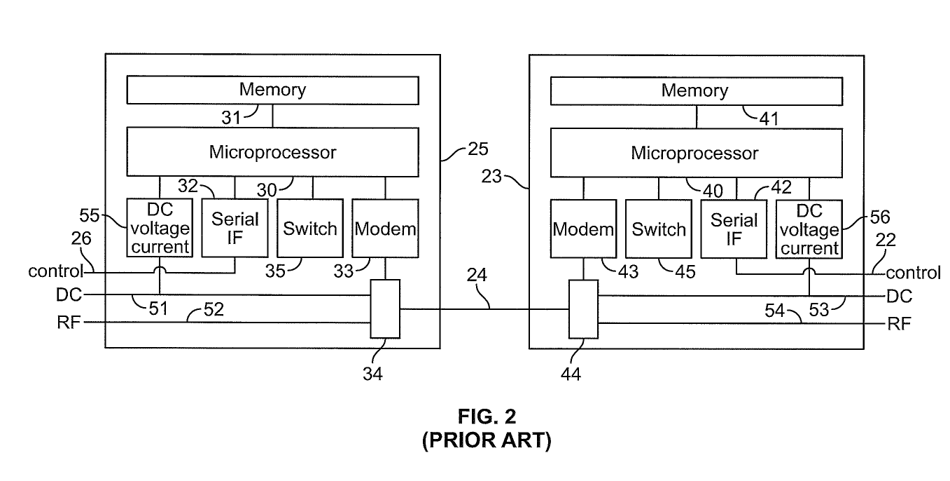

FIG. 3 is a schematic of a Standard Antenna Interface that may be used in the subject invention.

FIGS. 4-6 show the Antenna Interface of the subject invention.

FIG. 7 is a schematic of the Communication Base Station of the subject invention with an Bias-T.

FIG. 8 is a schematic of the Communication Base Station without a Bias-T.

### DETAILED DESCRIPTION OF SEVERAL EMBODIMENTS OF THE INVENTION

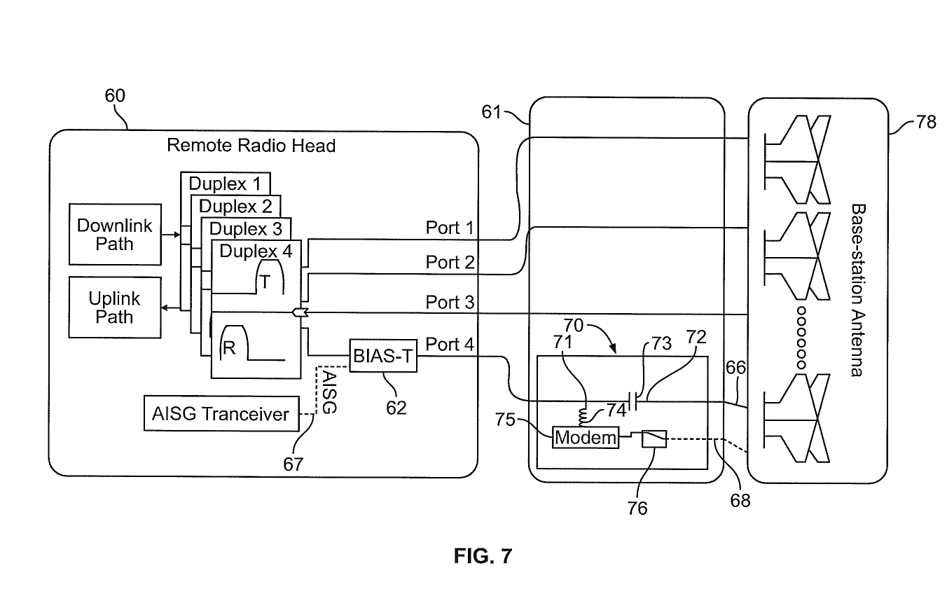

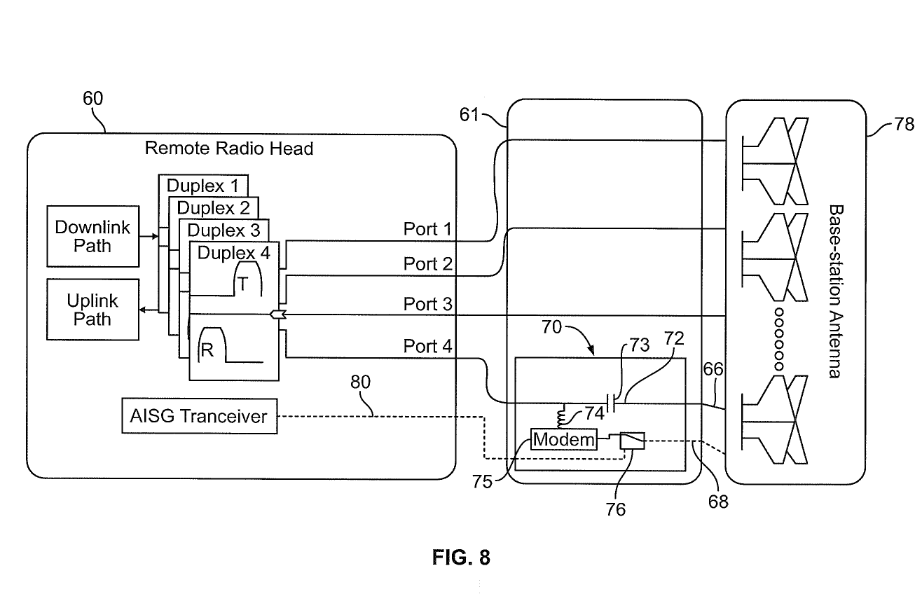

A wireless communications Base Station is illustrated in FIGS. 7 and 8 and can include a Remote Radio Head 60, a Interface 61 including an Input Selective Smart Bias Tee 62, and a RET Antenna 63 having an AISG controller 64. The Input Selective SBT 62 includes an RF Input 65, an RF output 66 to the Antenna 78, an AISG Input 67, and an AISG Output 68. While “input” and “output” are used herein with reference to a control data flow from the Remote Radio Head 60 to a RET Antenna 63, a person of ordinary skill would understand that the data transmission is bidirectional, and that data also flows from the RET Antenna 63 back to the Remote Radio Head 60.

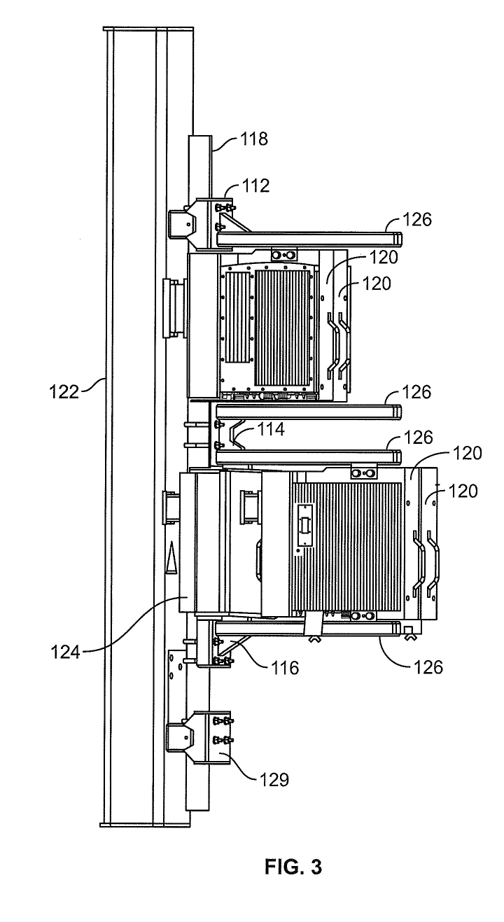

Referring to FIG. 3, one example of a Antenna Interface that may be used in the subject invention 110 is disclosed. In this example, an Upper Tower Mount 112, and Middle Tower Mount 114 and a Lower Tower Mount 116 are mounted on a Mounting Pole 118. The Upper Tower Mount 112, and Middle Tower Mount 114 and a Lower Tower Mount 116 are configured to mechanically interface with a plurality of Remote Radio Heads 120 and an Antenna 122. Preferably, the Upper Tower Mount 112, Middle Tower Mount 114 and Lower Tower Mount 116 are configured to mechanically interface with a Diplexer 124 placed between a Remote Radio Head 120 and the Antenna 122.

The example illustrated in FIG. 3 allows for the installation of up to four Remote Radio Heads 120. In an alternative example, when one or two Remote Radio Heads 120 are desired, the Middle Tower Mount 114 may be omitted.

The Upper Tower Mount 112 and the Lower Tower Mount 116 each include a Linear Guided Support 126. In the illustrated example, the Linear Guided Supports 126 comprise tracks that are configured to receive a roller trolley. However, alternative track and low friction car slide structures are within the scope of this invention and may be substituted. In this example, the Upper Tower Mount 112 includes an Antenna Mount 128. An additional Antenna Mount 129 is included on the Mounting Pole 118. The Antenna 122 includes Brackets 130, which include slots to engage Antenna Mount 128 and Antenna Mount 129. Middle Tower Mount 114 includes two Linear Guided Supports 126. The Linear Guided Supports 126 are on the opposite side of the Mounting Pole 118 from the Antenna 122 and extend away from the Antenna 122.

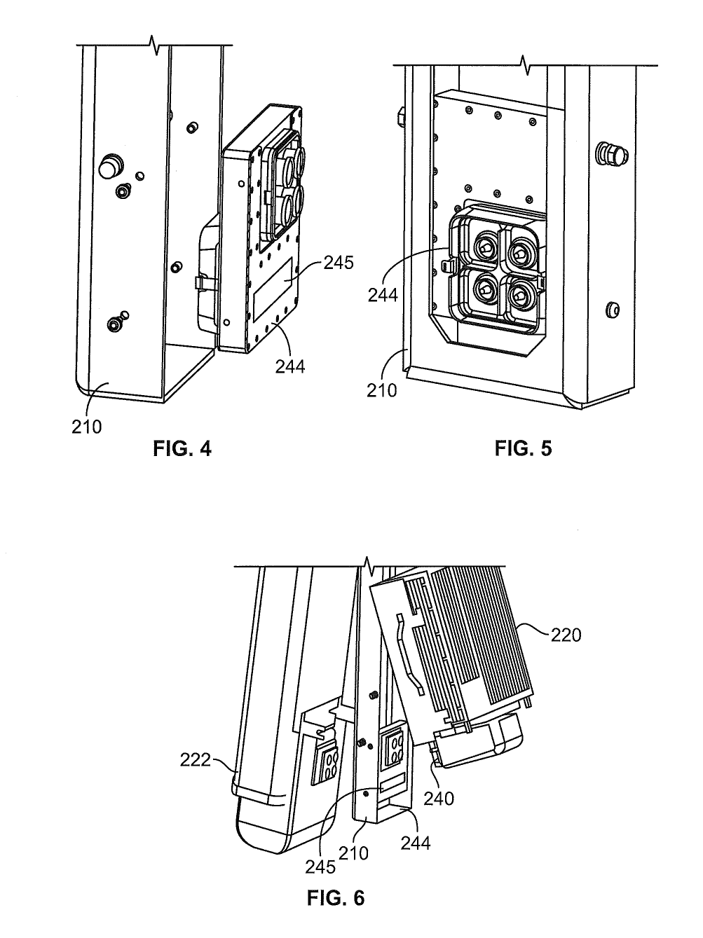

Referring to FIGS. 4, 5, and 6, an example of a Standard Antenna Interface 210 including an RF Interconnection Module 244 that may be used in the subject invention is illustrated. RRH Connection 240 of Remote Radio Head 220 engages one side of the RF Interconnection Module 244, and Antenna Connector 220 of Antenna 222 engages the other side of the RF Interconnection Module 244. On the RF interconnection Module 244, the Selective SBT input 245 is located.

Referring to FIGS. 7 and 8 and the Input Selective SBT portion 70 of the Standard Interface, the RF Input 71 is coupled to the RF Output 66 by a High Pass Filter 73 (illustrated as a capacitor). This allows a RF signal to pass through the Input Selective SBT, but not a DC component which may have been applied to the RF transmission line. The Input Selective SBT also includes a Low Pass Filter 74 (illustrated as an inductor), which allows control signals to pass to a Modem 75. The Modem 75 demodulates any control signals which may be present on the RF signal (typically on the order of 10 MHz), formats the control signals as an AISG data stream, and provides the AISG data stream to a first input on a Switch 76.

The Input Selective Smart Bias Tee further includes an AISG input. The AISG input is a digital input and conforms to, for example, Antenna Interface Standards Group Standard No. AISG v2.0 and/or Antenna Interface Standards Group Standard No. AISG v1.1. The AISG Input is coupled to a second input on the Switch 76. An output of the Switch 76 is coupled to the AISG Output 68. The Switch may comprise a set of conventional electromechanical switches, solid state electronic switches, or other suitable switching mechanism.

In one configuration (FIG. 8), the Remote Radio Head lacks a Smart Bias Tee, and an AISG cable 80 is connected between the Remote Radio Head and the AISG Input of the Standard Interface. The Remote Radio Head in this example transmits AISG control information as a digital signal on the AISG cable 80. In a second configuration (FIG. 7), the Remote Radio Head includes a Smart Bias Tee 62, and modulates AISG control information onto the RF Coaxial Cable 71, along with DC Bias power.

The Input Selective SBT 70 senses the presence of AISG control signals and/or DC bias power on either the RF Input 71 or the AISG Input 80, and then automatically couples the AISG control signals and DC bias power to the AISG Output, which is connected to an AISG input of the RET Antenna 78. For example, the Input Selective SBT 70 may sense a DC bias on the AISG Input 80 or digital activity on the AISG input 80, and then automatically select and connect the AISG input as the active communications channel. Also, the Modem 75 may detect a control signal and/or DC bias being passed to it via the Low Pass Filter 74, and automatically configure the Switch 76 to pass those control signals to the AISG output.

In this manner the antenna can be controlled with both RF input and AISG input. Should the Input Selection SBT sense an AISB signal, i.e., a DC bias, then the AISG control signals will be selected and automatically allowed to pass through switch 76 to the Antenna AISG input to control the antenna. If no DC bias is sensed, then the Input Selection SBT automatically permits the RF signal to pass to the RF output to the antenna for control by the RF signal. Thus, depending on the nature of the signal as sensed by the Input Selection SBT, the signal will be automatically directed to the corresponding antenna input.

If there is no DC bias on either the RF input or AISG input, the Input Selective Smart Bias Tee, then AISG control is not possible, and the Input Selective Smart Bias TEE will continuously monitor both interfaces until one is active, and then connect that interface.

Thus, the Standard Interface and the Input Selective SBT provides flexibility for the deployment of products since the Standard Interface will automatically configure itself to work with either of the two configurations set forth above. Additionally, the Standard Interface and Input Selective SBT facilitate reconfiguration from one RF-modulated AISG control signaling to digital AISG control signaling, and vice-versa.

It will be seen from the foregoing that this invention is one well adapted to attain the ends and objects set forth above, and to attain other advantages, which are obvious and inherent in the device. It will be understood that certain features and subcombinations are of utility and may be employed without reference to other features and subcombinations. This is contemplated by and within the scope of the claims. It will be appreciated by persons skilled in the art that the present invention is not limited to what has been particularly shown and described hereinabove. Rather, all matter herein set forth or shown in the accompanying drawings is to be interpreted as illustrative and not limiting.

1. An interface for powering and controlling an antenna, comprising:
an RF signal input;
an AISG signal input; and
a switch that is coupled to the antenna;
wherein the RF signal input is coupled to the antenna through a first filter and is coupled to a first input of the switch through a second filter, and
wherein the AISG signal input is coupled to a second input of the switch.

2. The interface of claim 1 wherein the first filter is a high pass filter.

3. The interface of claim 1 wherein the second filter is a low pass filter.

4. The interface of claim 1 wherein a signal received at the AISG signal input is an AISG signal that is generated by a AISG transceiver located in a remote radio head.

5. The interface of claim 1 wherein an RF signal and an AISG signal are coupled through a smart bias tee to the antenna.

6. A method for powering and controlling an antenna through an interface, comprising:
coupling an RF signal to the antenna through a first filter;
coupling a control signal and a DC power signal to the antenna through a switch that is included is the interface,
wherein if the control signal and DC power signal are received at an RF signal input of the antenna, the control signal and DC power signal are coupled through a second filter to a first input of the switch, and the first input of the switch is connected to an output of the switch, and if the control signal and DC power signal are received at an AISG signal input of the interface, the control signal and DC power signal are coupled to a second input of a switch, and the first input of the switch is connected to an output of the switch.

7. The method of claim 6 wherein the first filter is a high pass filter.

8. (canceled)

9. The method of claim 6 including the step of generating the AISG signal at an AISG transceiver located in a remote radio head.

10. The method of claim 6 including coupling the RF signal and the AISG signal through a smart bias tee to the RF signal input of the interface.

11. The interface of claim 1, wherein the interface is configured to connect the second input of the switch to the antenna if a control signal or a DC signal is present at the AISG signal input, and is configured to connect the first input of the switch to the antenna if the control signal or the DC signal is present at the RF signal input.

12. The interface of claim 1, further comprising a modem that is coupled between the RF signal input and the first input of the switch, the modem configured to demodulate any control signals received through the RF signal input.

13. The method of claim 6, wherein the second filter is a low pass filter.
